(19) United States
(12) Patent Application Publication
(10) Pub. No.: US 2017/0067525 A1
(43) Pub. Date: Mar. 9, 2017

(54) BRAKE FRICTION MATERIAL FOR STAINLESS STEEL DISC

(71) Applicants: Hyundai Motor Company, Seoul (KR); NAMYANG IND. CO., LTD., Ansan (KR); Saeron automotive Co., Ltd., Cheonan (KR)

(72) Inventors: Jai Min Han, Suwon (KR); Yoon Cheol Kim, Suwon (KR); Min Gyun Chung, Seongnam (KR); Byung Chan Lee, Suwon (KR); Jae Young Lee, Yongin (KR); Yoon Joo Rhee, Suwon (KR); Sung Jong Hong, Seoul (KR); Ki Jeong Kim, Siheung (KR); Hong Gyu Park, Cheonan (KR); Jae Heng Park, Cheonam (KR); Gook Hwa Hong, Cheonan (KR)

(21) Appl. No.: 14/957,361

(22) Filed: Dec. 2, 2015

(30) Foreign Application Priority Data
Sep. 9, 2015 (KR) 10-2015-0127867

(51) Int. Cl. F16D 69/02

(52) U.S. Cl. CPC F16D 69/025; F16D 65/092

(57) ABSTRACT

Disclosed is a brake friction material for stainless steel brake discs, as a non-asbestos-based organic friction material not including asbestos. The brake friction material can enhance braking characteristics and wear resistance of a stainless steel brake disc. The brake friction material for stainless steel discs comprises a fiber base, a binder, a filler and a friction modifier. In particular, the friction modifier is included in an amount of about 10 to 22% by volume based on the total volume of the brake friction material composition and comprises zirconium oxide (ZrO₂), iron oxide (FeO), graphite (C), tin (Sn) powder and alumina (Al₂O₃).

### CROSS-REFERENCE TO RELATED APPLICATION

This application claims the priority benefit of Korean Patent Application No. 10-2015-0127867, filed on Sep. 9, 2015 in the Korean Intellectual Property Office, the entire content of which is incorporated herein by reference.

### TECHNICAL FIELD

The present invention relates to a brake friction material for a stainless steel disc. The brake friction material for stainless steel brake may be a non-asbestos-based organic friction material which does not include asbestos and may improve braking characteristics and wear resistance of a stainless steel brake disc.

### BACKGROUND OF THE INVENTION

In general, vehicle brake systems are devices used to reduce vehicle speed, or stop or park vehicles. A brake disc and a brake friction material are important components performing braking function by changing kinetic energy of vehicles into thermal energy through friction.

Brake discs have mostly been made of gray cast iron having superior heat resistance and wear resistance. Brake friction materials have been manufactured by mixing about 20 raw materials in order to have high static frictional coefficient and stable dynamic frictional coefficient. Such raw materials are classified into a reinforced fiber, an abrasive material, a lubricant, a filler, and the like according to role thereof.

As a main ingredient of conventional friction materials, asbestos has been generally used due to low costs, superior thermal stability, high strength and superior dispersibility thereof. However, when people inhale asbestos dust, asbestos ingredients are accumulated in the lung and asbestosis which destroys lung tissues can be caused, thereby threatening health of workers.

In addition, frictional performance of friction materials containing asbestos is easily decreased at high temperature, thereby being easily worn out. In addition, asbestos dust is released into the atmosphere, thereby causing air pollution.

Accordingly, the United States Environmental Protection Agency has prohibited the use of asbestos fiber in the late 1980s, and thus, research into substitutes for asbestos fiber have been actively performed. As a result, reinforced fibers such as ceramic fiber, organic fiber, glass fiber, and the like have been developed.

For example, reinforced fibers used in brake friction materials have been broadly classified into a low-steel friction material containing iron fiber to reinforce a matrix, and a non-steel friction material containing organic aramid-based fiber instead of iron fiber.

Recently, in order to enhance braking characteristics of vehicles and various industrial machines, a non-asbestos organic (NAO), one of non-steel friction materials as a raw material of a friction material, has been used. In particular, the NAO has been applied to a drum lining, brake pad and the like which are installed in a vehicle brake system.

However, when a brake disc made of gray cast iron is used in humid environment such as Latin America, friction surfaces are corroded, and thus, braking characteristics and wear resistance are decreased.

Recently, in order to address such problems, a brake disc has been made of a stainless steel material having superior corrosion resistance. However, when a conventional friction material for brake discs made of gray cast iron is used, there are problems in braking characteristics and wear resistance.

The above disclosed background art has been provided to aid in understanding of the present invention and should not be interpreted as conventional technology known to a person having ordinary skill in the art.

### SUMMARY OF THE INVENTION

In preferred aspects, the present invention has been made in view of the above problems, and thus, the present invention provides a brake friction material for stainless steel discs. Particularly, the brake friction material of for steel discs may provide superior braking characteristics and wear resistance to a stainless steel brake disc.

In one aspect of the present invention, a brake friction material for stainless steel discs may be a non-asbestos-based organic friction material. The brake friction material composition may comprise: a fiber base, a binder, a filler and a friction modifier. Preferably, the friction modifier may be present in an amount of about 10 to 22% by volume based on the total volume of based on the total volume of the brake friction material composition. Further, the friction modifier may comprise zirconium oxide (ZrO₂), iron oxide (FeO), graphite(C), tin (Sn) powder and alumina (Al₂O₃).

The friction modifier may comprise an amount of about 5.0 to 9.0% by volume of zirconium oxide, an amount of about 2.0 to 5.0% by volume of iron oxide, an amount of about 2.0 to 5.0% by volume of graphite, an amount of about 0.5 to 2.0% by volume of tin powder and an amount of about 0.5 to 2.0% by volume of alumina, all the % by volume based on the total volume of the brake friction material composition.

Further, the friction modifier may consist of, consist essentially of, or essentially consist of the components of the composition as described herein. For instance, the friction modifier may consist of, consist essentially of, or essentially consist of: an amount of about 5.0 to 9.0% by volume of zirconium oxide, an amount of about 2.0 to 5.0% by volume of iron oxide, an amount of about 2.0 to 5.0% by volume of graphite, an amount of about 0.5 to 2.0% by volume of tin powder and an amount of about 0.5 to 2.0% by volume of alumina, all the % by volume, all the % by volume, all the % by volume based on the total volume of the brake friction material composition.

In the friction modifier, iron oxide and graphite may be mixed in the same volumetric ratio.

In the friction modifier, alumina and tin powder may be mixed in the same volumetric ratio.

The fiber base may be a hybrid fiber including aramid pulp, glass fiber and potassium titanate fiber, and may be included in an amount of about 20.0 to 28.0% by volume based on the total volume of the brake friction material composition.

Still further provided are vehicle parts that may comprise the brake friction material composition as described herein. Exemplary vehicle part may include a brake disc.

Other aspects of the invention are disclosed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a graph at a first effectiveness as comparing frictional coefficients of a gray cast iron brake disc, a stainless steel brake disc, a conventional friction material and a brake friction material for stainless steel discs according to an exemplary embodiment of the present invention using a dynamometer according to JASO C406 P1 in order to compare braking characteristics and wear resistance;

FIG. 2 illustrates a graph at a second effectiveness as comparing frictional coefficients of a gray cast iron brake disc, a stainless steel brake disc, a conventional friction material and a brake friction material for stainless steel discs according to an exemplary embodiment of the present invention using a dynamometer according to JASO C406 P1 in order to compare braking characteristics and wear resistance;

FIG. 3 illustrates a graph at a first fade and recovery as comparing frictional coefficients of a gray cast iron brake disc, a stainless steel brake disc, a conventional friction material and a brake friction material for stainless steel discs according to an exemplary embodiment of the present invention using a dynamometer according to JASO C406 P1 in order to compare braking characteristics and wear resistance;

FIG. 4 illustrates a graph at a second fade and recovery as comparing frictional coefficients of a gray cast iron brake disc, a stainless steel brake disc, a conventional friction material and a brake friction material for stainless steel discs according to an exemplary embodiment of the present invention using a dynamometer according to JASO C406 P1 in order to compare braking characteristics and wear resistance;

FIG. 5 illustrates a graph at a third effectiveness as comparing frictional coefficients of a gray cast iron brake disc, a stainless steel brake disc, a conventional friction material and a brake friction material for stainless steel discs according to an exemplary embodiment of the present invention using a dynamometer according to JASO C406 P1 in order to compare braking characteristics and wear resistance;

FIG. 6A illustrates image of a gray cast iron brake disc after performing braking characteristics and wear resistance of the gray cast iron brake disc and a conventional friction material using a dynamometer according to JASO C406 P1;

FIG. 6B illustrates image of the conventional friction material after performing braking characteristics and wear resistance of the gray cast iron brake disc and the conventional friction material using a dynamometer according to JASO C406 P1;

FIG. 7A illustrates image of a stainless steel brake disc after evaluating braking characteristics and wear resistance of the stainless steel brake disc and a conventional friction material using a dynamometer according to JASO C406 P1;

FIG. 7B illustrates image of the conventional friction material after evaluating braking characteristics and wear resistance of the stainless steel brake disc and the conventional friction material using a dynamometer according to JASO C406 P1;

FIG. 8A illustrates image of an exemplary stainless steel brake disc after evaluating braking characteristics and wear resistance of the stainless steel brake disc and a brake friction material for stainless steel discs according to an exemplary embodiment of the present invention using a dynamometer according to JASO C406 P1; and

FIG. 8B illustrates image of a brake friction material for stainless steel discs according to an exemplary embodiment of the present invention after evaluating braking characteristics and wear resistance of the stainless steel brake disc and the brake friction material using a dynamometer according to JASO C406 P1.

### DETAILED DESCRIPTION

The terminology used herein is for the purpose of describing particular embodiments only and is not intended to limit the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles, e.g., fuel derived from resources other than petroleum. As referred to herein, a hybrid vehicle is a vehicle that has two or more sources of power, for example both gasoline-powered and electric-powered vehicles.

Reference will now be made in detail to the preferred embodiments of the present invention, examples of which are illustrated in the accompanying drawings. Wherever possible, the same reference numbers will be used throughout the drawings to refer to the same or like parts.

A brake friction material for stainless steel discs according to various exemplary embodiments of the present invention may be a non-asbestos-based organic friction material. The brake friction material may include a fiber base, a binder, a filler and a friction modifier in order to provide superior braking characteristics and wear resistance to a stainless steel brake disc made of stainless steel.

The fiber base may be a hybrid fiber in which aramid pulp as a main ingredient, glass fiber, potassium titanate fiber, and the like are mixed. The aramid fiber may be a representative organic reinforced fiber added to a friction material, and may improve strength, frictional coefficient stability and wear resistance of a preform.

Such a fiber base may be preferably included in an amount of about 20.0 to 28.0% by volume based on the total volume of the brake friction material composition. Unless otherwise indicated herein, the volume % or % by volume as described herein is based on the total volume of the brake friction material or its composition.

When the fiber base is included in an amount of less than about 20.0% by volume, reinforcement effects to a binder may be reduced, and thus, strength of the friction material may be decreased. When the fiber base is included in an amount of greater than about 28% by volume, a remainder of the reinforced fiber which is not shared with the binder readily may fall off, and thus, wear resistance may be decreased. Accordingly, the content of the fiber base may range from about 20.0 to about 28.0% by volume.

The binder as used herein may not be particularly limited, and any binder materials generally used and publicly known binder may be used without limitation. For example, as the binder, a phenolic resin, a melamine resin, an epoxy resin, rubber, or mixtures thereof may be used.

Such a binder may combine the components of the friction material, thus enhancing strength and thermal stability of the friction material.

In the present invention, as a binder, a mixture of a phenolic resin in an amount of about 15.0 to 19.0% by volume and a rubber in an amount of about 4.0 to 7.0% by volume may be preferably used. Since fading of friction may occur when a binder is thermally decomposed particularly upon high-temperature operation, the mixture of the phenolic resin and the rubber which increases crosslinking density may be used as a binder.

Preferably, the binder may be included in an amount of about 19.0 to 26.0% by volume. When the binder is contained in an amount of less than about 19.0% by volume, binding force may be deceased and thus strength of the friction material may be decreased, and when the binder is contained in an amount of greater than about 26.0% by volume, an unbound binder may deteriorate braking characteristics. Accordingly, the content of the binder may range from about 19.0 to about 26.0% by volume.

In addition, the filler according to an exemplary embodiment of the present may include Cashew dust, barium sulfate and calcium hydroxide, but the present invention is not limited thereto. In addition, various fillers such as melamine dust, pulverized tire powder, and the like may be used.

The friction modifier according to an exemplary embodiment of the present invention may comprise zirconium oxide (ZrO₂), iron oxide (FeO), graphite(C), tin (Sn) powder and alumina (Al₂O₃), and friction modifier may be included in an amount of about 10.0 to 22.0% by volume based on the total volume of a friction material composition.

When the friction modifier is contained in an amount of less than about 10.0% by volume, coefficient of friction may be decreased, and thus, braking characteristics may be deteriorated. When the friction modifier is contained in an amount of greater than about 22.0% by volume, disc wear amount and torque amplitude may be increased, thereby causing noise. Accordingly, the amount of the friction modifier may range from about 10.0 to about 22.0% by volume.

Preferably, the friction modifier according to an exemplary embodiment of the present invention may include: an amount of about 5.0 to 9.0% by volume of zirconium oxide, an amount of about 2.0 to 5.0% by volume of iron oxide, an amount of about 2.0 to 5.0% by volume of graphite, an amount of about 0.5 to 2.0% by volume of tin powder, and an amount of about 0.5 to 2.0% by volume of alumina, all the % by volume based on the total volume of a friction material composition.

TABLE 1

| | Zirconium | Iron | | Tin | | | |
|---|---|---|---|---|---|---|---|
| | oxide | oxide | Graphite | powder | Alumina | Coefficient | |
| | (% by | (% by | (% by | (% by | (% by | of | Wear |
| | volume) | volume) | volume) | volume) | volume) | friction | amount |
| Example 1 | 7 | 3.5 | 3.5 | 1.0 | 1.0 | Superior | Superior |
| Example 2 | 8.5 | 2.5 | 2.5 | 0.5 | 0.5 | Superior | Superior |
| Example 3 | 5.5 | 4.5 | 4.5 | 1.5 | 1.5 | Superior | Superior |
| Comparative | 4.5 | 3.5 | 3.5 | 1.0 | 1.0 | 13% | Superior |
| Example 1 | | | | | | decrease | |
| Comparative | 9.5 | 3.5 | 3.5 | 1.0 | 1.0 | Superior | 20% |
| Example 2 | | | | | | | increase |
| Comparative | 7 | 1.5 | 1.5 | 1.0 | 1.0 | Superior | 50% |
| Example 3 | | | | | | | increase |
| Comparative | 7 | 5.5 | 5.5 | 1.0 | 1.0 | 15% | Superior |
| Example 4 | | | | | | decrease | |
| Comparative | 7 | 2.0 | 4.0 | 1.0 | 1.0 | 10% | Superior |
| Example 5 | | | | | | decrease | |
| Comparative | 7 | 4.0 | 2.0 | 1.0 | 1.0 | Superior | 15% |
| Example 6 | | | | | | | increase |
| Comparative | 7 | 3.5 | 3.5 | 0 | 0 | 10% | Superior |
| Example 7 | | | | | | decrease | |
| Comparative | 7 | 3.5 | 3.5 | 3.0 | 3.0 | Superior | 20% |
| Example 8 | | | | | | | increase |
| Comparative | 7 | 3.5 | 3.5 | 1.0 | 2.0 | Superior | 30% |
| Example 9 | | | | | | | increase |
| Comparative | 7 | 3.5 | 3.5 | 2.0 | 1.0 | 8% | Superior |
| Example | | | | | | decrease | |
| 10 | | | | | | | |

Table 1 shows frictional coefficient and wear amount changes in various compositions of the friction modifiers.

As described in Examples 1 to 3 of the present invention, it can be known that, when each ingredient of the friction modifier satisfies the above ranges, superior frictional coefficient and wear amount may be obtained.

Meanwhile, as described in Comparative Examples 1 and 2, it can be confirmed that, when zirconium oxide is included in an amount of less than about 5.0% by volume, frictional coefficient may be decreased, and thus, braking power may be decreased. When zirconium oxide is included in an amount of greater than about 9.0% by volume, wear amount may be increased, and thus, a reference value of wear resistance may be not satisfied.

Accordingly, the content of zirconium oxide may preferably range from about 5.0 to about 9.0% by volume.

In addition, as described in Comparative Examples 3 to 4, it can be confirmed that wear amount may be increased and thus wear resistance may be decreased when the content of iron oxide and graphite is less than about 2.0% by volume, and frictional coefficient may be decreased and thus a reference value of braking characteristics may not be satisfied when the content is greater than about 5.0% by volume.

Preferably, the iron oxide and the graphite may be contained in the same volumetric ratio. As shown in Comparative Example 5 to 6, when the content of the iron oxide and the graphite satisfies the above range but the iron oxide and the graphite are not contained in the same volumetric ratio, frictional coefficient may be decreased or wear amount may be increased and thus reference values of wear resistance and braking characteristics may not be satisfied.

In addition, as described in Comparative Examples 7 to 8, it can be confirmed that frictional coefficient may be decreased and thus braking power may be decreased when the total content of tin powder and alumina is less than about 1.0% by volume, and wear amount may be increased and thus a reference value of wear resistance may not be satisfied when the total content is greater than 4.0% by volume.

Preferably, the tin powder and the alumina may be contained in the same volumetric ratio. As described in Comparative Examples 9 to 10, when the content of the tin powder and the alumina satisfies the above range but the tin powder and the alumina are not contained in the same volumetric ratio, frictional coefficient may be decreased or wear amount may be increased and thus reference values of wear resistance and braking characteristics may not be satisfied.

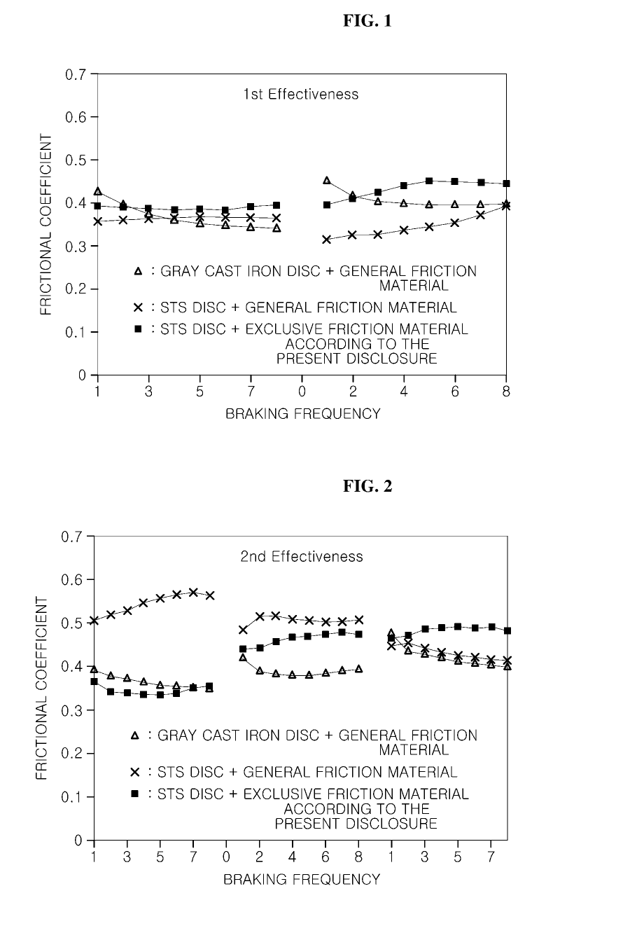

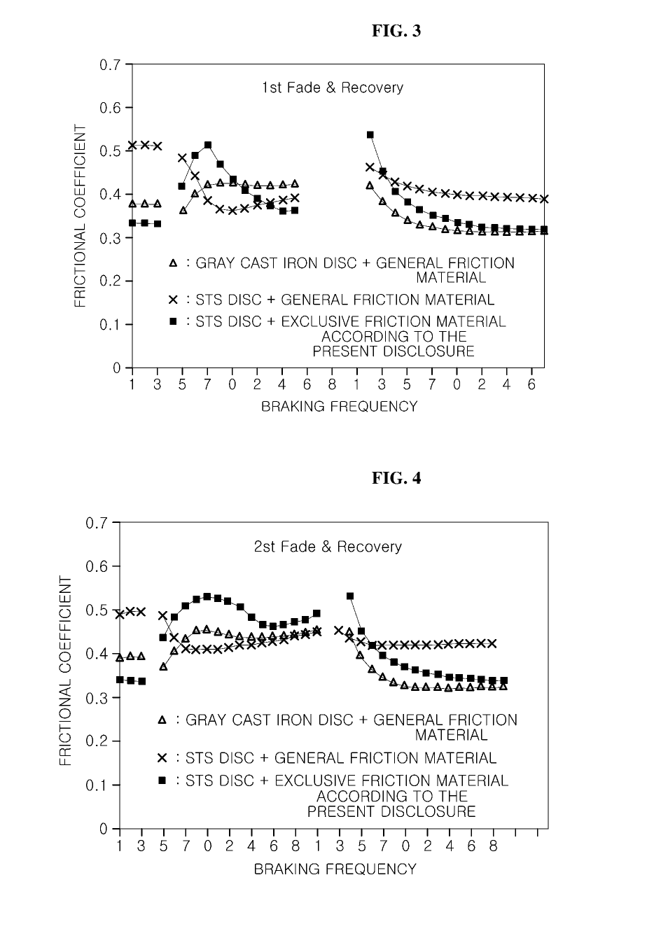

In the present invention, braking characteristics and wear resistance of a general gray cast iron brake disc, a stainless steel brake disc with a thickness of 6 mm as hot-rolled steel made of a STS420N1 material, a conventional friction material and the brake friction material for stainless steel discs according to an exemplary embodiment of the present invention were elevated using a dynamometer according to JASO C406 P1. Results are illustrated in FIGS. 1 to 5 and summarized in Table 2 below.

TABLE 2

| | | Stainless steel | |
|---|---|---|---|
| | Gray | disc + | Stainless steel |
| | cast iron disc + | conventional | disc + friction |
| | conventional | (general) | material of |
| | (general) | friction | the present |
| Classification | friction material | material | invention |
| Preburnish | 0.35 | 0.35 | 0.34 |
| 1st effectiveness | 0.39 | 0.35 | 0.41 |
| Burnish | 0.37 | 0.48 | 0.37 |
| 2nd effectiveness | 0.39 | 0.49 | 0.43 |
| 1st reburnish | 0.38 | 0.51 | 0.35 |
| 1st fade & recovery | 0.37 | 0.42 | 0.39 |
| 2nd reburnish | 0.38 | 0.49 | 0.34 |
| 2nd fade & recovery | 0.39 | 0.43 | 0.42 |
| 3rd reburnish | 0.39 | 0.48 | 0.35 |
| 3rd effectiveness | 0.41 | 0.45 | 0.41 |

As shown in FIGS. 1 to 5 and Table 2, when the stainless steel brake disc and the conventional general friction material are combined, overall frictional average coefficient may be excessively increased, a frictional coefficient change level may be maximum per each section, frictional coefficient may be decreased when operation is performed at low speed to high speed, and frictional coefficient may be excessively decreased in a section in which high-temperature characteristics (e.g., fade) are exhibited, compared to the case that the gray cast iron brake disc and the conventional general friction material are combined.

However, it can be confirmed that, when the stainless steel brake disc and the brake friction material for stainless steel discs according to an exemplary embodiment of the present invention are combined, most of the problems may be addressed, overall frictional average coefficient may be the same as the case in which the gray cast iron brake disc and the conventional general friction material are combined, and superior braking characteristics may be obtained.

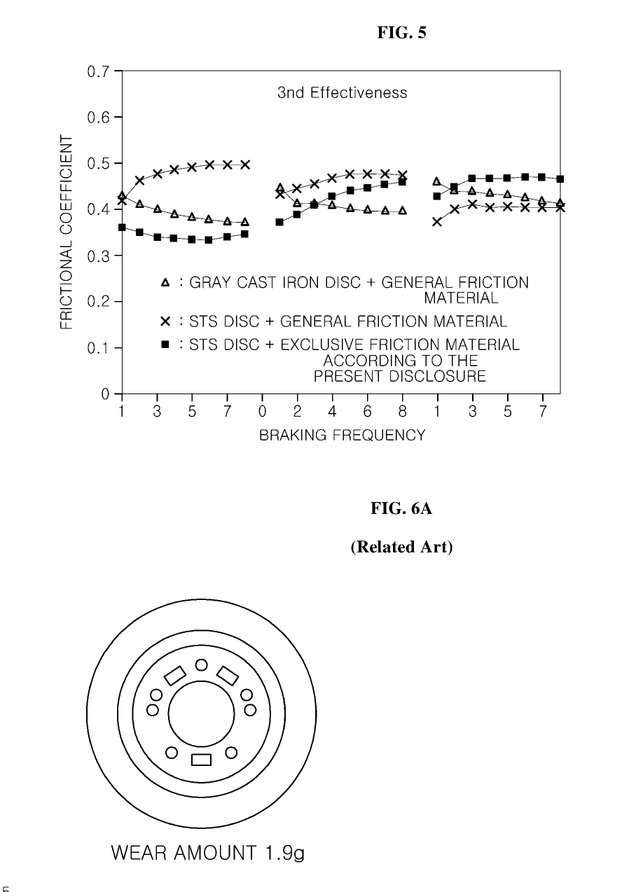

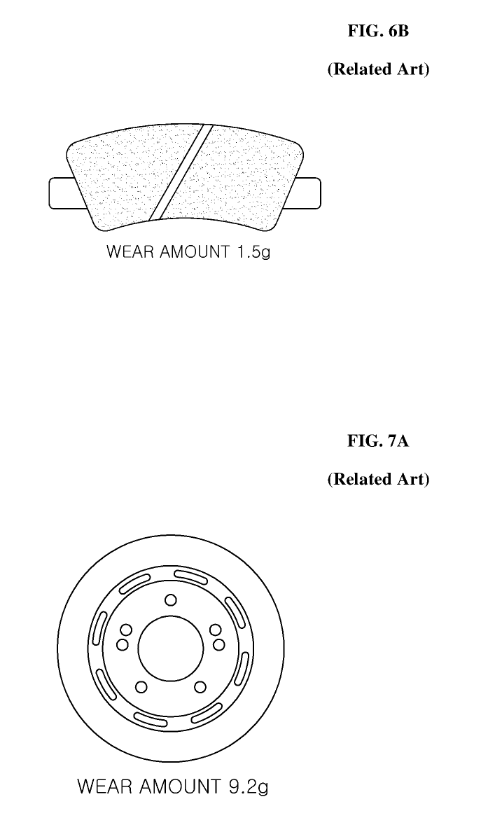

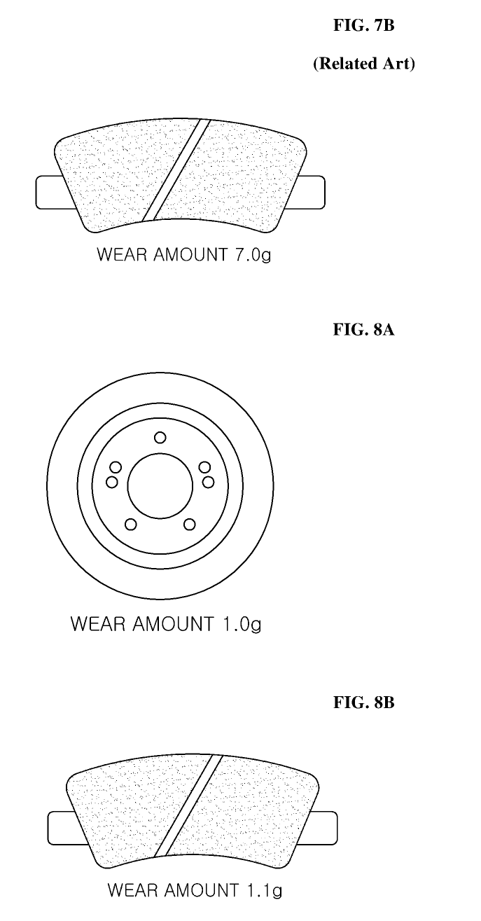

FIGS. 6A to 8B illustrate the gray cast iron brake disc and the conventional friction material, the stainless steel brake disc and the conventional friction material, and the stainless steel brake disc and the brake friction material for stainless steel discs according to an exemplary embodiment of the present invention, after braking characteristic and wear resistance thereof were evaluated.

As illustrated in FIGS. 6A to 8B, it can be confirmed that, when the brake friction material for stainless steel discs according to an exemplary embodiment of the present invention and the stainless steel brake disc are combined, wear resistance may be greatly enhanced, compared to the case in which the gray cast iron brake disc and the conventional friction material, or the stainless steel brake disc and the conventional friction material are combined.

As described above, when the friction material for stainless steel brake discs is secured and applied to vehicles according to various exemplary embodiments of the present invention, corrosion resistance and braking characteristics of a disc may be substantially improved.

Thus, the present invention provides superior braking characteristics and wear resistance to a stainless steel brake disc and may substantially improve safety of vehicles even in humid environment.

In addition, durability of a braking device in hot and humid environment may be substantially improved.

Although the various exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A brake friction material composition for stainless steel discs, comprising:
a fiber base;
a binder;
a filler; and
a friction modifier,
wherein the friction modifier is present in an amount of 10 to 22% by volume based on a total volume of the brake friction material composition, and the friction modifier comprises zirconium oxide (ZrO₂), iron oxide (FeO), graphite (C), tin (Sn) powder and alumina (Al₂O₃).

2. The brake friction material composition according to claim 1, wherein the friction modifier comprises an amount of about 5.0 to 9.0% by volume of zirconium oxide, an amount of about 2.0 to 5.0% by volume of iron oxide, an amount of about 2.0 to 5.0% by volume of graphite, an amount of about 0.5 to 2.0% by volume of tin powder and an amount of about 0.5 to 2.0% by volume of alumina, all the % by volume based on a total volume of the brake friction material composition.

3. The brake friction material composition according to claim 1, wherein the friction modifier consists essentially of an amount of about 5.0 to 9.0% by volume of zirconium oxide, an amount of about 2.0 to 5.0% by volume of iron oxide, an amount of about 2.0 to 5.0% by volume of graphite, an amount of about 0.5 to 2.0% by volume of tin powder and an amount of about 0.5 to 2.0% by volume of alumina, all the % by volume based on the total volume of the brake friction material composition.

4. The brake friction material composition according to claim 2, wherein, in the friction modifier, iron oxide and graphite are mixed in equal volumetric ratios.

5. The brake friction material composition according to claim 2, wherein, in the friction modifier, alumina and tin powder are mixed in equal volumetric ratios.

6. The brake friction material composition according to claim 1, wherein the fiber base is a hybrid fiber comprising aramid pulp, glass fiber and potassium titanate fiber.

7. The brake friction material composition according to claim 1, wherein the brake friction material comprises the fiber base in an amount of about 20.0 to 28.0% by volume based on the total volume of the brake friction material composition.

8. A vehicle part that comprises a brake friction material composition of claim 1.

9. The vehicle part of claim 8 is a brake disc.
